(19) United States
(12) Patent Application Publication
(10) Pub. No.: US 2013/0138865 A1
(43) Pub. Date: May 30, 2013

(54) SYSTEMS, METHODS, AND DEVICES FOR RUNNING MULTIPLE CACHE PROCESSES IN PARALLEL

(71) Applicant: Seagate Technology LLC, Cupertino, CA (US)

(72) Inventors: YoungSun Park, Korea (KR); JunSeok Shim, Korea (KR)

(73) Assignee: Seagate Technology, LLC, Cupertino, CA (US)

(21) Appl. No.: 13/682,790

(22) Filed: Nov. 21, 2012

(30) Foreign Application Priority Data
Nov. 24, 2011 (KR) 10-2011-0123860

(51) Int. Cl. G06F 12/02

(52) U.S. Cl. CPC G06F 12/0238; G06F 12/02
USPC 711/102; 711/120

(57) ABSTRACT

Certain embodiments of the present disclosure related to systems, methods, and devices for increasing data access speeds.

In certain embodiments, a method includes running multiple cache retrieval processes in parallel, in response to a read command.

In certain embodiments, a method includes initiating a first cache retrieval process and a second cache retrieval process to run in parallel, in response to a single read command.

### RELATED APPLICATION

Pursuant to 35 U.S.C. §119(a), this application claims the benefit of Korean Application No. 10-2011-0123860, filed on Nov. 24, 2011, the contents of which is incorporated by reference herein in its entirety.

### SUMMARY

Certain embodiments of the present disclosure are related to systems, methods, and devices for increasing data access speeds.

In certain embodiments, a method includes running multiple cache retrieval processes in parallel, in response to a read command.

In certain embodiments, a method includes initiating a first cache retrieval process and a second cache retrieval process to run in parallel, in response to a single read command.

### BRIEF DESCRIPTION OF THE DRAWINGS

FIG. 1 is a block diagram illustrating a data storage system, in accordance with certain embodiments of the present disclosure.

FIG. 2 is a flow chart illustrating a read command routine, in accordance with certain embodiments of the present disclosure.

FIG. 3 is a block diagram illustrating a data storage system, in accordance with certain embodiments of the present disclosure.

FIG. 4 is a flow chart illustrating a data transfer method, in accordance with certain embodiments of the present disclosure.

FIG. 5 is a configuration diagram illustrating an operation principle of direct memory access (DMA), in accordance with certain embodiments of the present disclosure.

FIG. 6 is a configuration diagram illustrating a mail box, in accordance with certain embodiments of the present disclosure.

FIG. 7 is a flow chart illustrating an operation principle of the first and the second data box illustrated in FIG. 6.

FIG. 8 is a block diagram illustrating a data storage system, in accordance with certain embodiments of the present disclosure.

FIG. 9 is a flow chart illustrating a data transfer method of a hybrid drive, in accordance with certain embodiments of the present disclosure.

FIG. 10 is a configuration diagram illustrating a mail box illustrated in FIG. 8.

### DETAILED DESCRIPTION

The present disclosure relates to data storage devices, systems, and methods involving multiple tiers of caching. For example, data storage devices, systems, and methods can include multiple types of storage memory—each with their own advantages and disadvantages. Once the advantages and disadvantages are understood, multiple types of storage memories can be combined in a complimentary manner to create efficient data storage systems and devices.

Certain embodiments of the present disclosure are accordingly directed to systems, devices, and methods for increasing data access speeds.

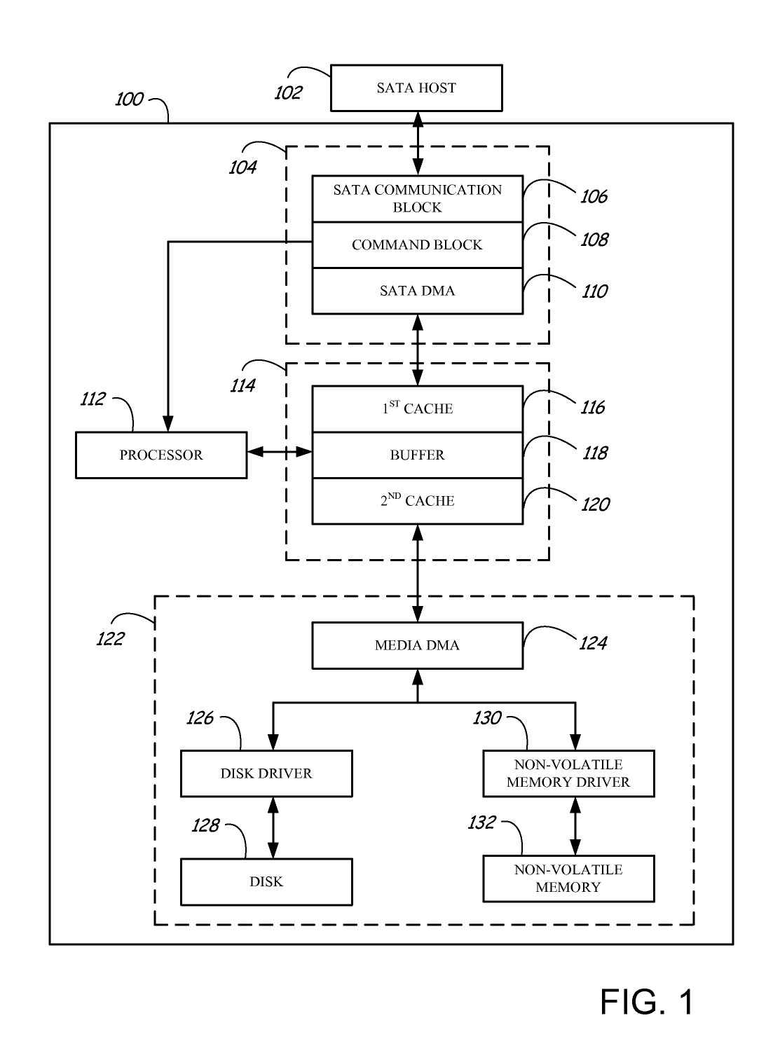

FIG. 1 is a block diagram illustrating a system 100 including a SATA interface block 104, processor 112, buffer unit 114, and disk block 122. SATA is just one example of a standard interface that can be used. The disclosure is not limited to this specific interface.

The SATA interface block 104 exchanges a command or data with a SATA host 102, and may include a SATA communication block 106, a command block 108, and SATA direct memory access (DMA).

The SATA communication block 106 communicates with the SATA host 102. The command block 108 receives and stores a command sent by the SATA host 102. The SATA DMA stores data sent by the SATA host 102 in the buffer 118 through the SATA communication block 106 or transfers the data of the buffet' 118 to the SATA host 102 through the SATA communication block 106.

The processor 112 analyzes a command received through the command block 108 to control the hybrid drive 100.

The buffer unit 114 may include a first cache 116 and a second cache 120. The buffer 118 temporarily stores data exchanged between the SATA host 102 and storage block 122.

The storage block 122 may include a media DMA 124, disk driver 126, disk 128, non-volatile memory driver 130, and non-volatile memory 132.

The media DMA 124 enables the transfer of data between the buffer 118 and the disk 128 or non-volatile memory 132 without the help or intervention of a separate processor 112.

The disk 128 and non-volatile memory 132 store user data, and the disk driver 126 and non-volatile memory driver 130 read or write data according to a format of the disk 128 and non-volatile memory 132, respectively.

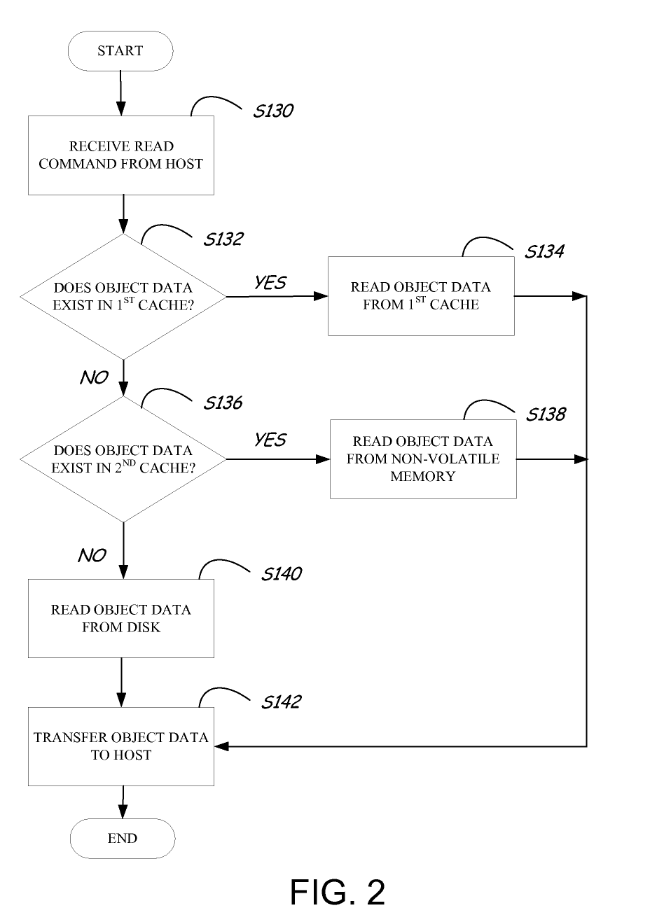

FIG. 2 is a flow chart illustrating a read command execution in the system 100. The SATA host 102 transfers a read command for reading requested data from the storage block 122 to the command block 108, and the command block 108 transfers the transferred read command to the processor 112 (S130).

The processor 112 runs a retrieval process to retrieve the requested data from the first cache 116 (S132). The processor 112 reads the requested data from the first cache 116 (S134) if the requested data exists in the first cache. The processor 112 reads the requested data from the non-volatile memory 132 (S138) if the requested data exists in the second cache. If the requested data is not retrieved from the first or second cache, then the requested data is read from the disk.

Once read, the requested data is transferred to the SATA host 102 through the SATA interface block 104 (S142). Accordingly, the transfer of the requested data is delayed as much as a retrieval time of the first cache 116 when the requested data is stored in the non-volatile memory 132, and the transfer of the requested data is delayed as much as a retrieval time of the first cache 116 and second cache 120 when there exists the requested data in the disk 128.

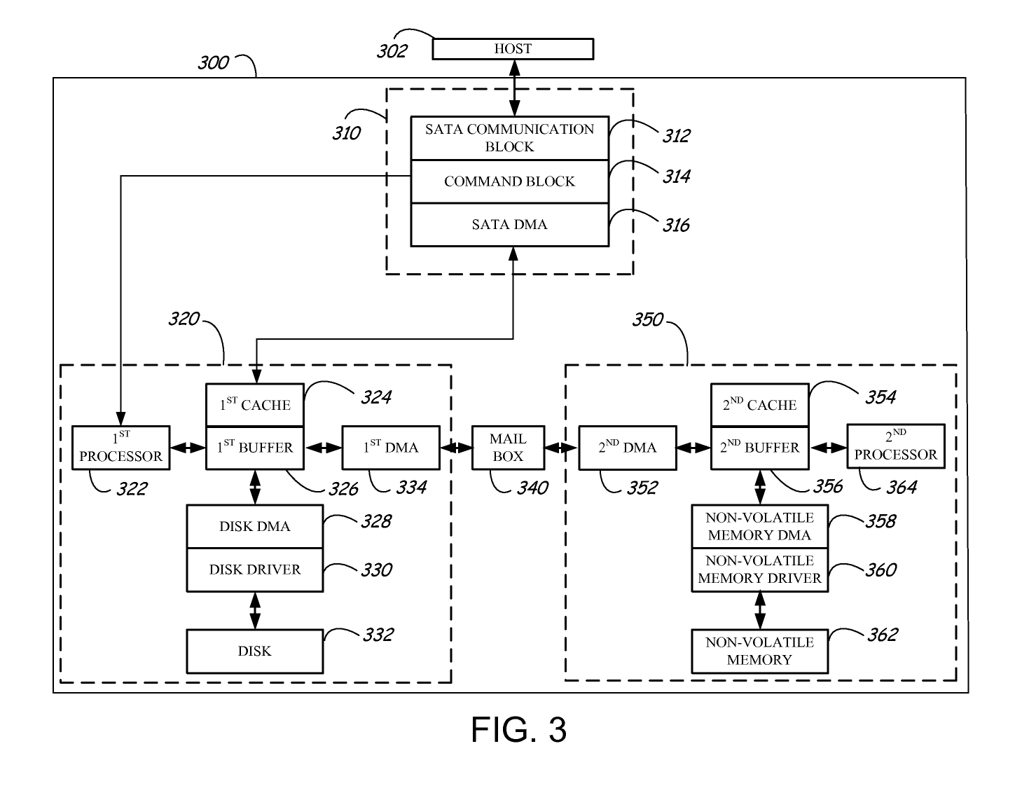

FIG. 3 is a block diagram illustrating the system 300 including an interface block 310, disk block 320, mail box 340, and non-volatile memory block 350.

The interface block 310 exchanges a command or data with the host 302. The interface block 310 may include a communication block 312, command block 314, and DMA 316.

The communication block 312 communicates with the host 302. The command block 314 receives and stores a command sent by the host 302 and transfers the command to the disk block 320. The DMA 316 stores data sent by the host 302 in the first buffer 326 through the communication block 312 or transfers the data of the first buffer 326 to the host 302 through the communication block 312.

The disk block 320 may include a first processor 322, first cache 324, first buffer 326, disk DMA 328, disk driver 330, disk 332, and first DMA 334.

The first processor 322 receives a command of the host 302 through the command block 314 and controls the disk block 320 accordingly.

The disk DMA 328 transfers data between the first buffer 326—which may be a DRAM cache—and the disk 332. The disk driver 330 may read or write data according to a format of the disk 332. The disk 332 may be a magnetic recording disk. The first DMA 334 transfers data between the first buffer 326 and the mail box 340. The mail box 340 exchanges a control signal or data between the disk block 320 and the non-volatile memory block 350.

The non-volatile memory block 350 may include a second DMA 352, second cache 354, second buffer 356, non-volatile memory DMA 358, non-volatile memory driver 360, non-volatile memory 362, and second processor 364.

The second DMA 352 transfers data between the second buffer 356 and the mail box 340. The second cache 354 stores data storage information within the non-volatile memory 362, and the second buffer 356 temporarily stores data exchanged between the mail box 340 and the non-volatile memory 362. The second cache 354 or second buffer 356 may be a cache with a fast data access speed, such as a DRAM cache.

The non-volatile memory DMA 358 transfers data between the second buffer 356 and the non-volatile memory 362. The non-volatile memory driver 360 enables data to be read or written according to a format of the non-volatile memory 362. The non-volatile memory 362 stores user data and may be but is not limited to a flash memory, RRAM, or PRAM.

The second processor 364 receives a command of the host 302 through the mail box 340 and controls the non-volatile memory block 350.

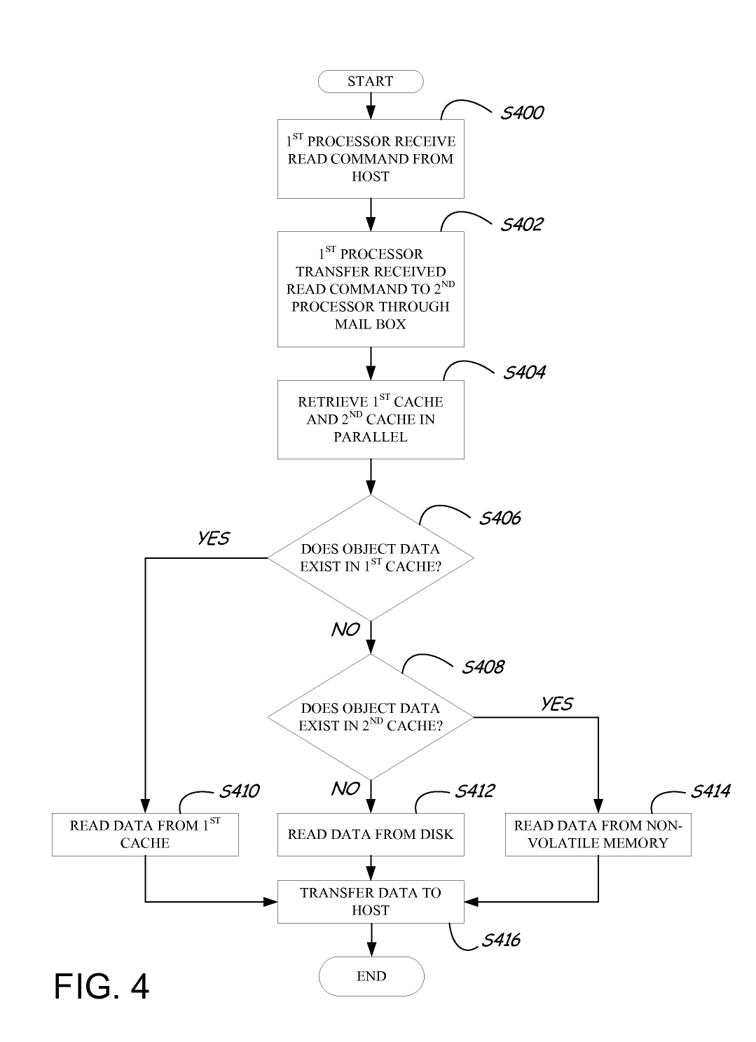

FIG. 4 is a flow chart illustrating a data transfer method of the system 300. Referring to FIGS. 3 and 4, the command block 314 stores a read command sent by the host 302, and transfers it to the first processor 322 of the disk block 320 (S400). The first processor 322 transfers the transferred read command to the second processor 364 through the mail box 340 (S402).

The first processor 322 and second processor 364 initiate parallel retrieval processes in response to the read command sent by the host 302 (S404).

When the first retrieval result is a hit (e.g., when the requested data is found in the first cache 324), the first processor 322 reads the requested data from the first cache 324 (S410) and transfers it to the host 302 through the SATA interface block 310 (S416). When the first retrieval result is a miss (e.g., when the requested data cannot be found in the first cache 324), the first processor 322 receives a second retrieval result by the second processor 364 through the mail box 340 (S408).

When the second retrieval result is a hit (e.g., when the requested data is found in the non-volatile memory 362), the second processor 364 reads the requested data from the non-volatile memory 362 (S414) and temporarily stores the requested data in the second buffer. The second processor 364 transfers the temporarily-stored requested data to the first buffer 326 through the mail box 340, and the first processor 322 temporarily stores the transferred requested data in the first buffer 326. The first processor 322 transfers the temporarily-stored requested data to the host 302 through the interface block 310 (S416).

When the second retrieval result is a miss (e.g., when the requested data cannot be found in the non-volatile memory 362), the first processor 322 reads the requested data from the disk 332 (S412) and temporarily stores it in the first buffer 326. The first processor 322 transfers the temporarily-stored requested data to the host 302 through the interface block 310 (S416).

In certain embodiments, the second processor 364 receives the read command transferred from the host 302 through the mail box 340, and the second processor 364 retrieves the requested data from in the second cache 354 in parallel with the requested data retrieval in the first cache 324. Accordingly, when requested data exists in the non-volatile memory 362 or disk 332, retrieval is carried out in the second cache 354—regardless of whether requested data exists in the first cache 324, thereby obtaining a fast data access speed.

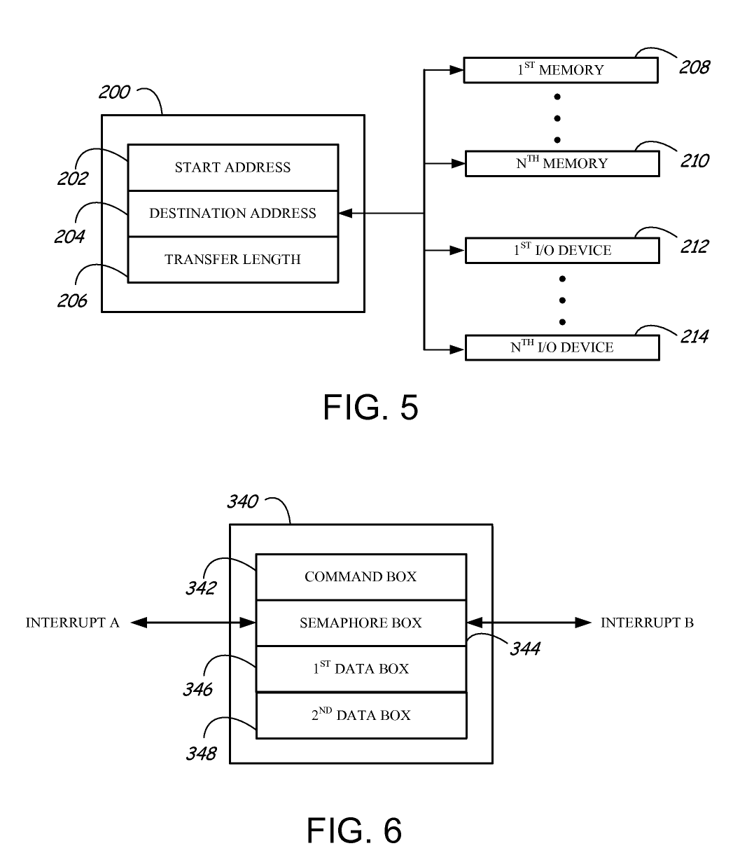

FIG. 5 is a diagram illustrating an operation principle of DMA 200. The DMA 200 is a module configured to enable data transfer without the help of a separate processor when only a start address 202, destination address 204, and transfer length 206 are specified. In other words, memories 1 (208) through N (210) or I/O devices 1 (212) through N (214) sharing a bus with the DMA may have a non-duplicated address, and thus the DMA 200 enables the transfer of data without the help of a processor. The SATA DMA 316, first DMA 334, disk DMA 328, second DMA 352, and non-volatile memory DMA 358 illustrated in FIG. 3 may have a structure of the DMA 200, and enable data transfer without the help of a separate processor.

FIG. 6 is a diagram illustrating the mail box 340 illustrated in FIG. 3. Referring to FIGS. 3, 4, and 6, the mail box 340 may include a command box 342; at least two data boxes 346, 348; and a semaphore box 344.

The command box 342 stores a read command transferred by the first processor 322 and then transfers the read command to the second processor 364 or stores a second retrieval result transferred by the second processor 364 and then transfers it to the first processor 322.

Data boxes 346, 348 store data to be transferred from either one of the disk block 320 and non-volatile memory block 350 to the counterpart.

The semaphore box 344 stores a plurality of semaphore bits determining a control authority of the mail box 340. The plurality of semaphore bits correspond to any one of the data boxes 346, 348, respectively, and determine which one of the first processor 322 and the second processor 364 has a control authority.

For example, it is assumed that the first processor 322 has an authority capable of accessing a data box through the first DMA 334 when the semaphore bit is “0,” and the second processor 364 has an authority capable of accessing a data box through second DMA 352 when the semaphore bit is “1.”

If the semaphore bit is “01,” then the first processor 322 has an authority capable of accessing a first data box 346 and the second processor 364 has an authority capable of accessing a second data box 348.

If the semaphore bit is changed, then the control authority of the mail box 340 is transferred to the counterpart processor, and the control authority transfer situation is delivered to each processor through interrupt A or interrupt B.

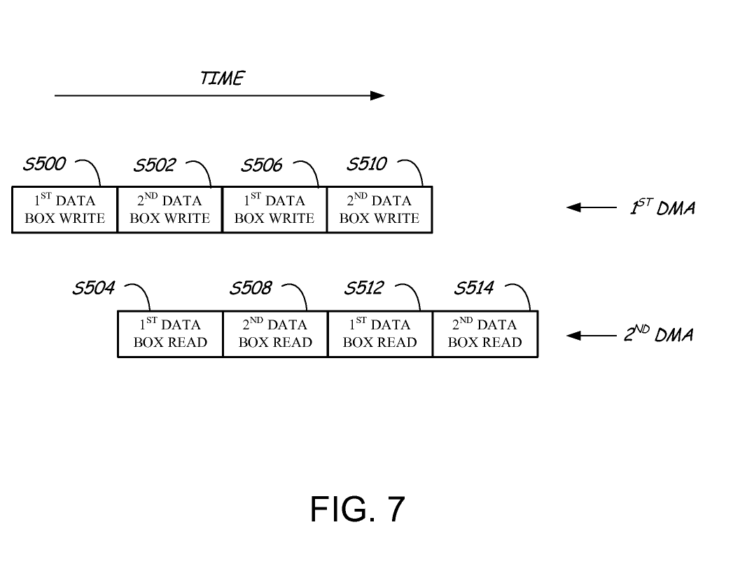

FIG. 7 is a flow chart illustrating an operation principle of the first and the second data box 348 illustrated in FIG. 6.

Referring to FIGS. 6-7, when data is to be transferred from the first DMA 334 to the second DMA 352, the first DMA 334 first writes first data to the first data box 346 (S500), and the command box 342 transfers a command for transferring the first data from the first DMA 334 to the second DMA 352 to the second DMA 352. After the writing of the first data to the first data box 346 is completed, the semaphore box 344 changes a semaphore bit corresponding to the first data box 346 to transfer the control authority transfer situation to the second DMA 352 using interrupt B. The second DMA 352 reads the first data of the first data box 346 based on a transfer command of the data received from the mail box 340 and the control authority transfer situation (S504). Furthermore, the first DMA 334 writes second data while the second DMA 352 reads the first data of the first data box 346 (S502).

When the reading of the first data by the second DMA 352 and the writing of the second data by the first DMA 334 are completed, the semaphore box 344 changes a semaphore bit to transfer the control authority transfer situation to the first DMA 334 and second DMA 352, respectively, using interrupt A and interrupt B. The second DMA 352 reads the second data of the second data box 348 in response to a transfer command of the data received from the mail box 340 and the control authority transfer situation (S508). Furthermore, the first DMA 334 writes the third data of the first data box 346 while the second DMA 352 reads the second data of the second data box 348 (S506).

In other words, the first DMA 334 alternately writes each data to either one of the first data box 346 and second data box 348, and the second DMA 352 alternately reads the data of the data box in which data write is completed by the first DMA 334 (S500 through S514). This configuration may be utilized when the first DMA 334 and second DMA 352 cannot access either one of the data boxes 346, 348 at the same time.

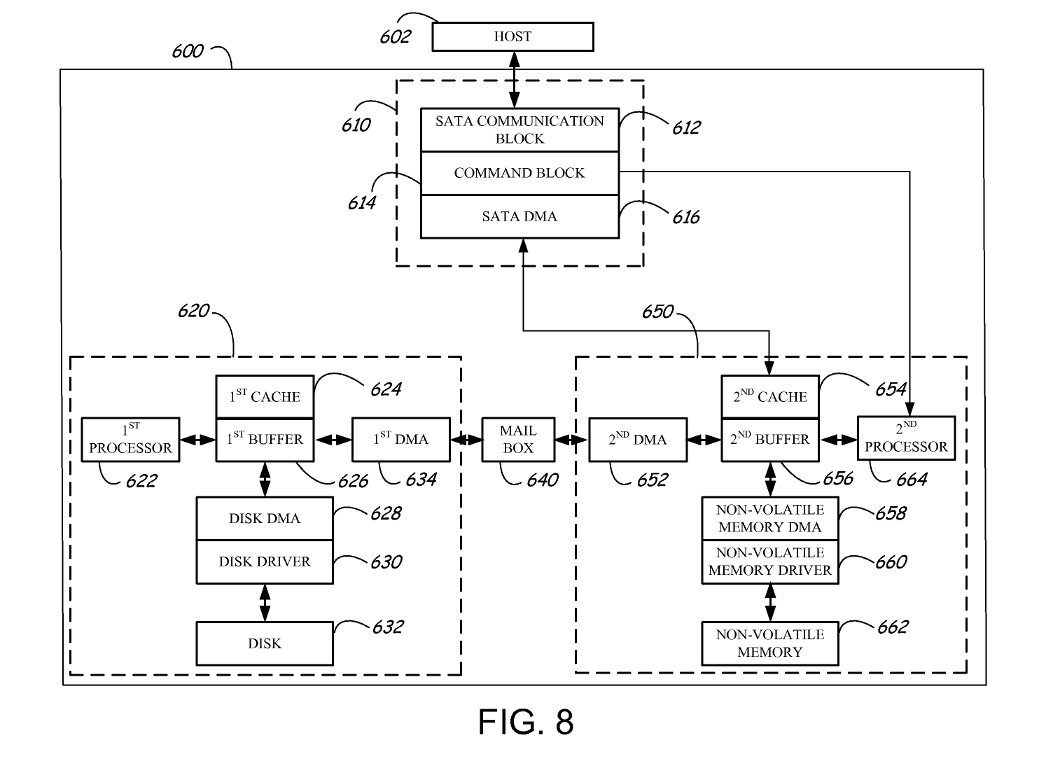

FIG. 8 is a block diagram illustrating a system 600 including an interface block 610, disk block 620, mail box 640, and non-volatile memory block 650.

The interface block 610 exchanges a command or data with the host 602. The interface block 610 may include a communication block 612, command block 614, and DMA 616.

The communication block 612 communicates with the host 602. The command block 614 receives and stores a command sent by the host 602 and transfers it to the disk block 620. The DMA 616 stores data sent by the host 602 in the second buffer 656 through the communication block 612 or transfers the data of the second buffer 656 to the host 602 through the communication block 612.

The disk block 620 may include a first processor 622, first cache 624, first buffer 626, disk DMA 628, disk driver 630, disk 632, and first DMA 634.

The first processor 622 receives a command of the host 602 through the mail box 640 and controls the disk block 620 according to this. The first cache 624 compensates a relatively slow data access speed of the disk block 620, and the first buffer 626 temporarily stores data exchanged between the mail box 640 and the disk 632. The first cache 624 or first buffer 626 may be a cache with a fast data access speed, such as a DRAM cache.

The disk DMA 628 transfers data between the first buffer 626 and the disk 632. The disk driver 630 reads or writes data according to a format of the disk 632. The disk 632 stores user data and may be a magnetic recording disk.

The first DMA 634 transfers the data between the first buffer 626 and the mail box 640. The mail box 640 takes charge of exchanging a control signal or data between the disk block 620 and the non-volatile memory block 650.

The non-volatile memory block 650 may include a second DMA 652, second cache 654, second buffer 656, non-volatile memory DMA 658, non-volatile memory driver 660, non-volatile memory 662, and second processor 664.

The second DMA 652 takes charge of transferring data between the second buffer 656 and the mail box 640.

The second cache 654 stores data storage information within the non-volatile memory 662. The second buffer 656 temporarily stores the data exchanged between the host 602 and the non-volatile memory 662. In certain embodiments, the second cache 654 may be a non-volatile memory cache, and the second buffer 656 may be a DRAM cache with a fast data access speed.

The non-volatile memory DMA 658 transfers data between the second buffer 656 and the non-volatile memory 662. The non-volatile memory driver 660 enables data to be read or written according to a format of the non-volatile memory 662. The non-volatile memory 662 stores user data and may be a flash memory, RRAM, or PRAM.

The second processor 664 receives a command of the host 302 through the interface block 610, and controls the non-volatile memory block 650 according to this,

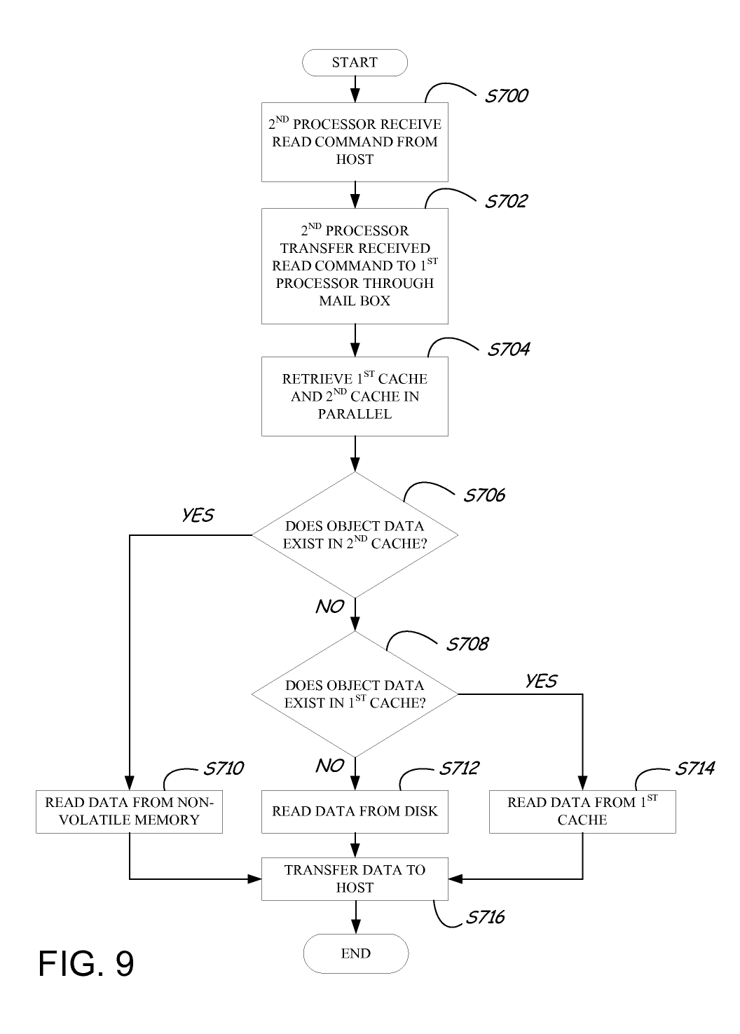

FIG. 9 is a flow chart illustrating a data transfer method of the system 600. Referring to FIGS. 8 and 9, the command block 614 stores a read command sent by the host 602 and transfers it to the second processor 664 of the non-volatile memory block 650 (S700). The second processor 664 immediately transfers the transferred read command to the first processor 662 through the mail box 640 (S702).

The first processor 622 and second processor 664 retrieve whether or not there exists requested data in the first cache 624 and second cache 654, respectively, in parallel, according to the read command sent by the host 602 (S704). In other words, the first processor 622 retrieves whether or not there exists the requested data within the first cache 624 to output a first retrieval result (S708), and the second processor 664 retrieves whether or not there exists the requested data within the second cache 654 to output a second retrieval result (S706).

When the second retrieval result is a hit (e.g., when the requested data is found in the non-volatile memory 662), the second processor 664 reads the requested data from the non-volatile memory 662 (S710). When the second retrieval result is a miss (e.g., when the requested data cannot be found in the non-volatile memory 662), the second processor 664 receives the first retrieval result by the first processor 622 through the mail box 640 (S708).

When the first retrieval result is a hit (e.g., when the requested data is found the first cache 624), the first processor 622 reads the object data from the first cache 624 (S714), and transfers the requested data to the second buffer 656 through the mail box 640. The second processor 664 transfers the requested data temporarily stored in the second buffer 656 to the host 602 through the SATA interface block 610 (S716).

When the first retrieval result is a miss (e.g., when the requested data cannot be found in the first cache 624), the first processor 622 reads the requested data from the disk 632 (S712) and temporarily stores it in the first buffer 626. The first processor 622 transfers the temporarily stored requested data to the second buffer 656 through the mail box 640. The second processor 664 transfers the requested data temporarily stored in the second buffer 656 to the host 602 through the SATA interface block 610 (S716).

The first processor 662 (1) receives a read command transferred from the host through the mail box and (2) retrieves requested data from the first cache 624 in parallel with the requested data retrieval in the second cache. Accordingly, when requested data exists in the first cache 624 or disk 632, retrieval is carried out in the first cache 624—regardless of whether the requested data exists in the second cache, thereby obtaining a fast data access speed.

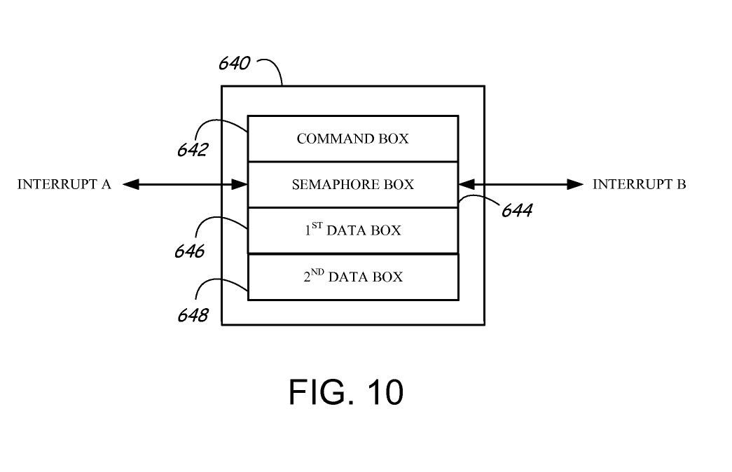

FIG. 10 is a configuration diagram illustrating the mail box 640 illustrated in FIG. 8. Referring to FIGS. 4 through 6, the mail box 640 may include a command box 642; at least two data boxes 646, 648; and a semaphore box 644.

The command box 642 stores a read command transferred by the second processor 622 and then transfers the read command to the first processor 664 or stores a first retrieval result transferred by the first processor 664 and then transfers it to the second processor 622.

Data boxes 646, 648 store data to be transferred from either one of the disk block 620 and non-volatile memory block 650 to the counterpart.

The semaphore box 644 stores a plurality of semaphore bits determining a control authority of the mail box 640. The plurality of semaphore bits correspond to any one of the data boxes 646, 648, respectively, and determine which one of the first processor 622 and the second processor 664 has a control authority.

It is assumed that the first processor 622 has an authority capable of accessing a data box through the first DMA 634 when the semaphore bit is “0,” and the second processor 664 has an authority capable of accessing a data box through second DMA 652 when the semaphore bit is “1.”

If the semaphore bit is “1,” then the first processor 622 has an authority capable of accessing a first data box 646 and the second processor 664 has an authority capable of accessing a second data box 648.

If the semaphore bit is changed, then the control authority of the mail box 640 is transferred to the counterpart processor, and the control authority transfer situation is delivered to each processor through interrupt A or interrupt B.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed. For example, the various systems described throughout the detailed description can be embodied in a single device like a hybrid hard drive, or a single device like a laptop, or more broadly like an enterprise storage system.

What is claimed is:

1. A method comprising:
initiating a first cache retrieval process and a second cache retrieval process to run in parallel, in response to a single read command.

2. The method of claim 1, wherein the single read command is a request to retrieve data.

3. The method of claim 2, wherein the first retrieval process includes retrieving the requested data from a first cache, and wherein the second retrieval process includes retrieving the requested data from a second cache.

4. The method of claim 3, wherein the first cache is a DRAM cache and the second cache is a non-volatile memory cache.

5. The method of claim 3, further comprising:
reading the requested data from a magnetic recording disk if neither of the first nor second retrieval processes result in retrieving the requested data.

6. The method of claim 3, further comprising:
transferring the requested data through a mail box to a host.

7. The method of claim 2, wherein the single read command is initiated by a host.

8. The method of claim 2, wherein the single read command is initiated by a host.

9. The method of claim 1, wherein a mail box facilitates a transfer of the single read command from a first processor, which runs the first cache retrieval process, to a second processor, which runs the second cache retrieval process.
